(19) United States
(12) Patent Application Publication
(10) Pub. No.: US 2007/0120020 A1
(43) Pub. Date: May 31, 2007

(54) Small reusable payload delivery vehicle

(75) Inventor: Johnnie Engelhardt, West Columbia, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: MEI Technologies, Inc., Houston, TX (US)

(21) Appl. No.: 11/288,536

(22) Filed: Nov. 29, 2005

(51) Int. Cl. B64G 1/00

(52) U.S. Cl. 244/173.1

(57) ABSTRACT

The present invention provides a small unmanned payload delivery vehicle that can deploy one or more payloads into space and then bring the payloads back to earth. The delivery vehicle can be sent into space by an expendable launch vehicle, a space shuttle, or be launched from the space station. The delivery vehicle together with the payload contained therein can be left in space for a variable period of time, and the attitude of the delivery vehicle can be adjusted from time to time to maintain the vehicle in the desired orbit. When it is time to return the payload to earth, the delivery vehicle is de-orbited and re-enters the earth's atmosphere. The descent of the delivery vehicle is controlled by a parachute system packed within the vehicle. The delivery vehicle together with the payload contained therein can finally be retrieved based on signals emitted from a beacon.

### BACKGROUND

The present invention relates generally to small payload delivery vehicles and, more particularly, to a small delivery vehicle that can be deployed into space and then returned to earth.

Microgravity (also called zero-gravity) is the condition of near weightlessness that results when an object undergoes free fall, or is placed at a great distance from massive objects like the Earth. Scientists are interested in microgravity because many physical and biological processes work differently in a low gravity environment.

Microgravity opens a new universe of research possibilities. It unmasks phenomena that gravity on Earth can obscure. Researchers can perform in outer space microgravity experiments that may not be possible on Earth, and experiments in the microgravity environment continue to yield surprising and useful results.

Outer space not only provides an environment for microgravity experiments, it also offers an environment for testing the effects of radiation on many physical and biological materials or processes. To be cost effective, it is desirable to have a small delivery vehicle that can deliver experiments to space and, later, bring them back to earth for further analysis. The delivery vehicle described in the present disclosure may be used to fulfill such a need in the art.

### SUMMARY

In one embodiment, the present invention provides a small payload delivery vehicle that can be used to deploy one or more payloads into space and, subsequently, bring the payload back to earth. The delivery vehicle comprises a payload compartment, an attitude control system, a separation mechanism, a parachute recovery package, and a thermal protection system. The delivery vehicle can be sent into space by an expendable launch vehicle, a space shuttle, or launched from a space station. After being separated from the flight vehicle by the separation mechanism, the delivery vehicle together with the payload contained therein can be left in space for a variable period of time. To maintain the delivery vehicle in a certain orbit, the attitude of the delivery vehicle can be adjusted from time to time. When it is time to return the payload to earth, the delivery vehicle is de-orbited and re-enters the earth's atmosphere. The descent of the delivery vehicle is controlled by parachutes packed within the vehicle. The delivery vehicle together with the payload contained therein can finally be retrieved based on signals emitted from a beacon.

### BRIEF DESCRIPTION OF THE DRAWINGS

FIG. 1 illustrates a block diagram for a small payload delivery vehicle in accordance with one embodiment of the present invention.

FIG. 2 illustrates one embodiment of a small payload delivery vehicle adapted for use with an expendable launch vehicle.

FIG. 3 illustrates a closed free-flight configuration of one embodiment of a small payload delivery vehicle in accordance with the present invention.

FIG. 4 illustrates an open free-flight configuration of one embodiment of a small payload delivery vehicle in accordance with the present invention.

FIG. 5 illustrates one embodiment of a small payload delivery vehicle with a streamer deployed.

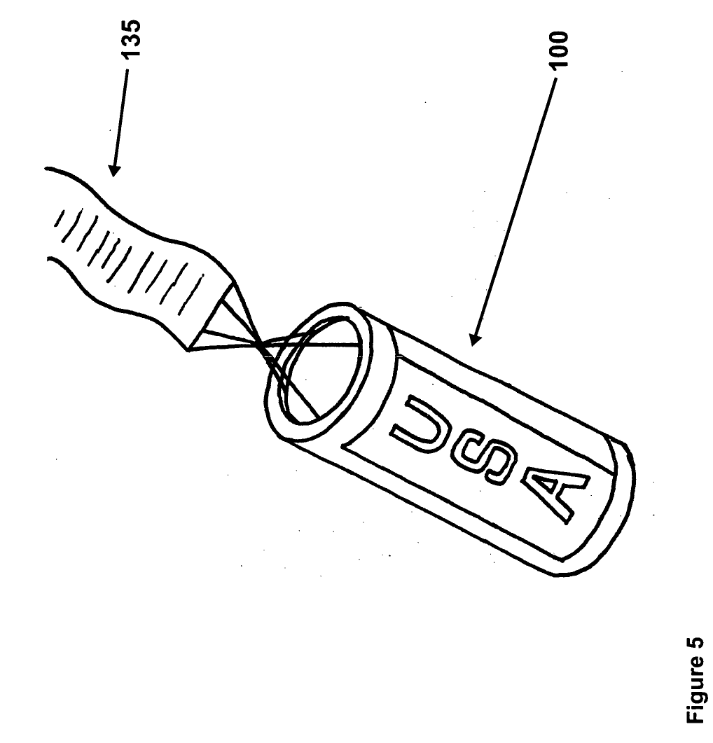

FIG. 6 illustrates one embodiment of a small payload delivery vehicle with a drogue deployed.

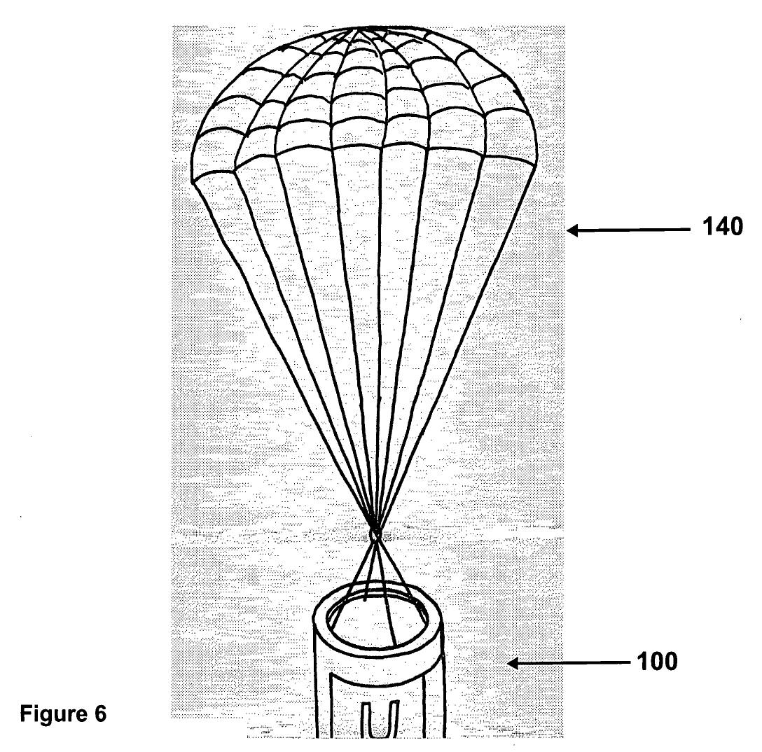

### DETAILED DESCRIPTION

The present invention provides a small unmanned payload delivery vehicle that may be used to deploy one or more payloads into space and, later, bring the payload back to earth. The delivery vehicle is relatively small and inexpensive, and can be sent into substantially any desired orbit. For example, the unmanned payload delivery vehicle can be sent into space from the United States Space Transport System (i.e., the Space Shuttle) or an expendable launch vehicle. Alternatively, the described payload delivery vehicle may be launched into space from a space station. The delivery vehicle can be maintained in space for hours or years, thereby providing a platform for space-based experiments. In one embodiment, the delivery vehicle can deliver a payload for microgravity or radiation experiments on many physical or biological materials. The delivery vehicle together with the payload is eventually returned to earth so that post-test analysis can be done.

The following descriptions are presented to enable any person skilled in the art to make and use the invention as claimed and is provided in the context of the particular examples discussed below, variations of which will be readily apparent to those skilled in the art. Accordingly, the claims appended hereto are not intended to be limited by the disclosed embodiments, but are to be accorded their widest scope consistent with the principles and features disclosed herein.

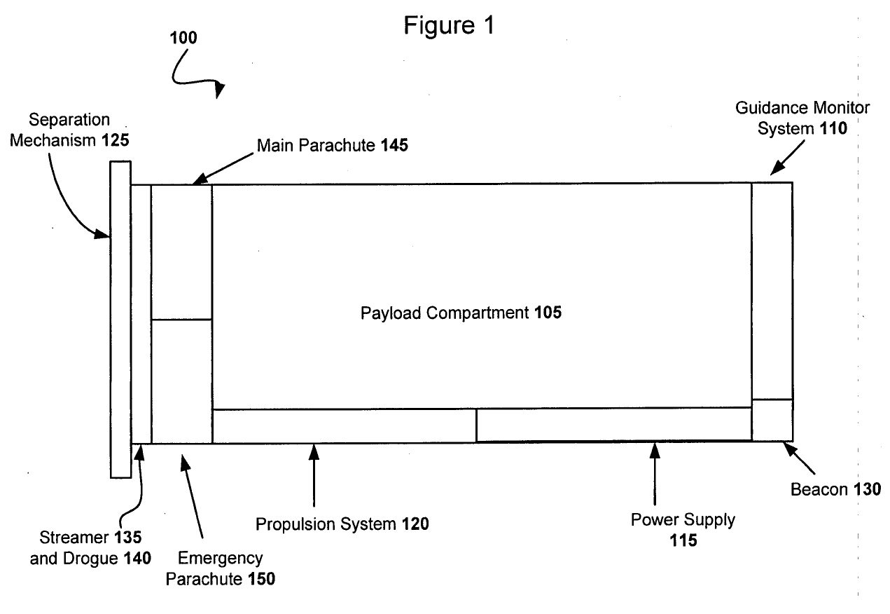

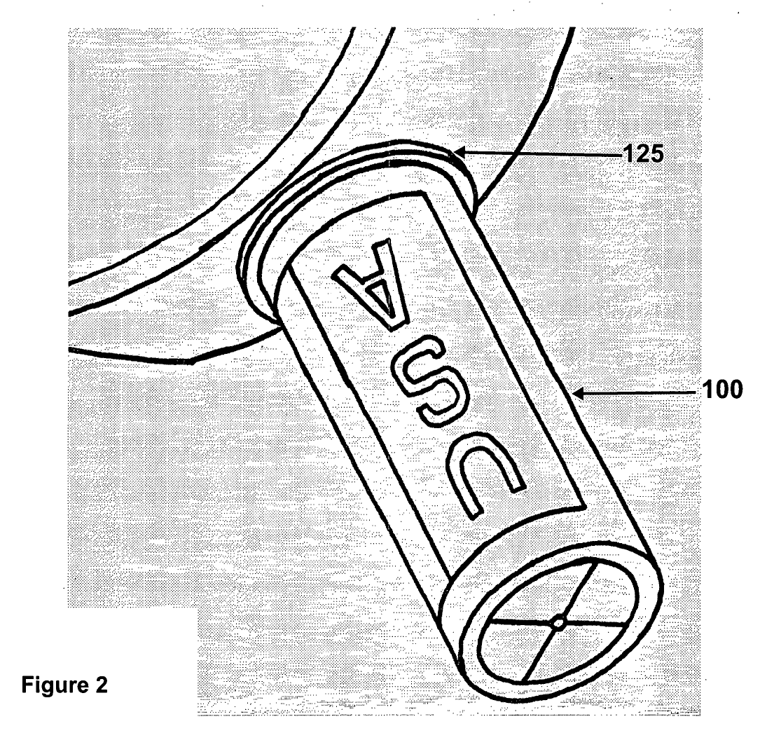

Referring to FIG. 1, small payload delivery vehicle 100 in accordance with one embodiment of the present invention comprises payload compartment 105, guidance monitor system 110, power supply 115, propulsion system 120, separation mechanism 125, beacon 130, and a parachute recovery system comprising streamer 135, drogue 140, main parachute 145, and emergency parachute 150. Payload delivery vehicle 100 may be fabricated from commonly used material such as aluminum, titanium or stainless steel, and the delivery vehicle can be configured in any suitable geometry. In one embodiment, delivery vehicle 100 can be a cylindrical tube fabricated from 2 inch aluminum plates that are ribbed to reduce weight without substantially reducing its strength. Preferably, the cylindrical tube is about 53 inches long and has an inner diameter of about 19 inches and an outer diameter about 21.5 inches. A delivery vehicle with such dimensions is capable of holding about 200 pound payload. An exemplary delivery vehicle configured in cylindrical shape is shown in FIG. 2.

A variety of techniques can be used to protect delivery vehicle 100 from thermal damage upon re-entry to the Earth's atmosphere. Early research on missile reentry vehicles found that “blunt body” designs would deflect much of the heat of reentry away from the vehicle. Thus, instead of having needle-noses, the reentry vehicles would have blunt flattened noses that formed a thick shockwave ahead of the vehicles to both deflect the heat and slow the vehicles down more quickly. Reentry vehicles have also been coated with ablative materials that absorbed heat, charred, and either flaked off or vaporized upon reentry, thereby taking away the absorbed heat. Blunt body designs and ablative materials have been used, for example, on the Gemini and Apollo spacecrafts, and one of skills in the art would readily adapt these designs and materials to the delivery vehicles of the present invention.

More recently, a number of silica-based insulation materials (tiles) have been developed and used in the United State Space Shuttle program. There are two main types of tiles, referred to as Low-temperature Reusable Surface Insulation (LRSI) and High-temperature Reusable Surface Insulation (HRSI). LRSI tiles cover areas where the maximum surface temperature runs between 700 and 1,200 degrees Fahrenheit (370 and 650 degrees Celsius). These tiles have a white ceramic coating that reflects solar radiation while in space. HRSI tiles cover areas where the maximum surface temperature runs between 1,200 and 2,300 degrees Fahrenheit (650 and 1,260 degrees Celsius). They have a black ceramic coating that helps them radiate heat during reentry. Two other types of tiles, known as Fibrous Refractory Composite Insulation and Toughened Unipiece Fibrous Insulation, also protect against temperatures between 1,200 and 2,300 degrees Fahrenheit. Areas where temperatures exceed 2,300 degrees Fahrenheit during entry are protected by a material called Reinforced Carbon-Carbon.

Over the years, many of the tiles have been replaced by a material known as Flexible Reusable Surface Insulation, or FRSI, and Advanced Flexible Reusable Surface Insulation, or AFRSI. FRSI and AFRSI cover areas that do not exceed 700 degrees Fahrenheit (370 degrees Celsius) during entry. These materials are lighter and less expensive than the conventional tiles and using them has enabled the Shuttle to lift heavier payloads to orbit. FRSI/AFRSI is sometimes referred to as a “thermal blanket.”

In another approach, instead of relying on continuous shunting of heat to prevent structural materials from melting, metallic alloys or ceramics that don't melt—or even lose strength—at any temperature encountered during re-entry may be used. Illustrative materials of this type include titanium- or nickel-based alloys and silicon carbide ceramic reinforced with carbon fibers.

In view of the techniques and materials developed in the United States Space Program described above, it is apparent that some of these protective materials may be adapted to confer heat protection on delivery vehicle 100 described herein.

The embodiment of the delivery vehicle 100 described above can be deployed into space by a payload deployment system described in U.S. Pat. No. 6,776,375, the specification of which is incorporated herein by reference. The deployment system of the '375 patent comprises an external shell or tube within which an internal cargo unit is placed, wherein the internal cargo unit is deployed by ejecting it from the external shell. Thus, in one embodiment, delivery vehicle 100 can be configured to fit into the external shell of the '375 patent and be deployed by the deployment system of the '375 patent, which in turn is attached to a space flight vehicle such as a Space Shuttle, an expendable launch vehicle or a space station. The timing of launching the delivery vehicle can be controlled by personnel located in a space shuttle, space station, or on the ground through, for example, radio control.

Alternatively, delivery vehicle 100 may be launched by directly attaching it to a launch vehicle through separation mechanism 125. Representative examples of separation mechanism include, but are not limited to, Lightband separation system from Planetary Systems Corporation of Silver Spring, Md., or a Clamp (Marmon) Band separation system from Starsys Research Corporation of Boulder, Colo. Activation of separation system 125 may be initiated by personnel located in a Space Shuttle, space station, or on the ground through, for example, radio control. An embodiment of a payload delivery vehicle directly attached to an expendable launch vehicle is shown in FIG. 2.

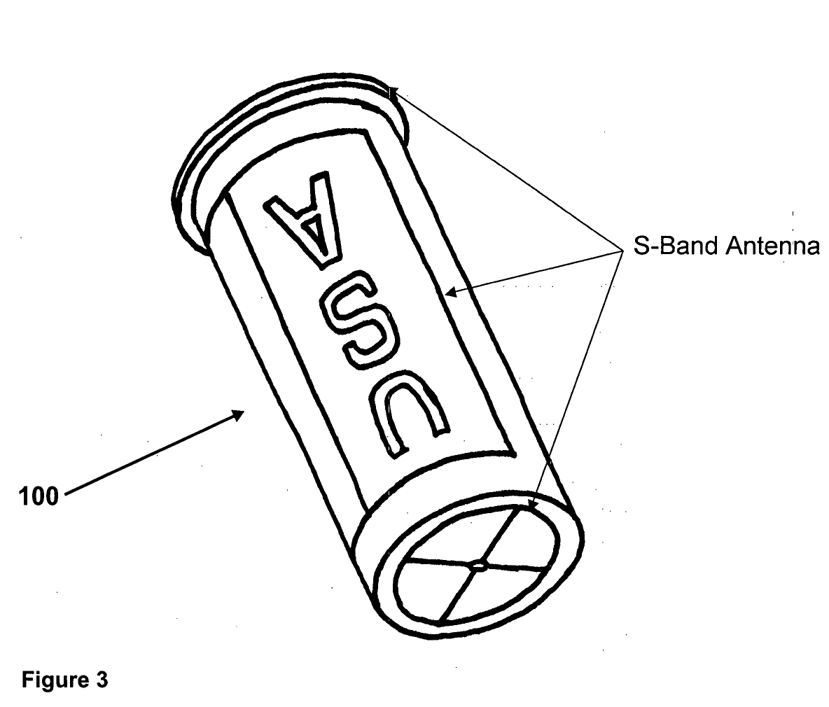

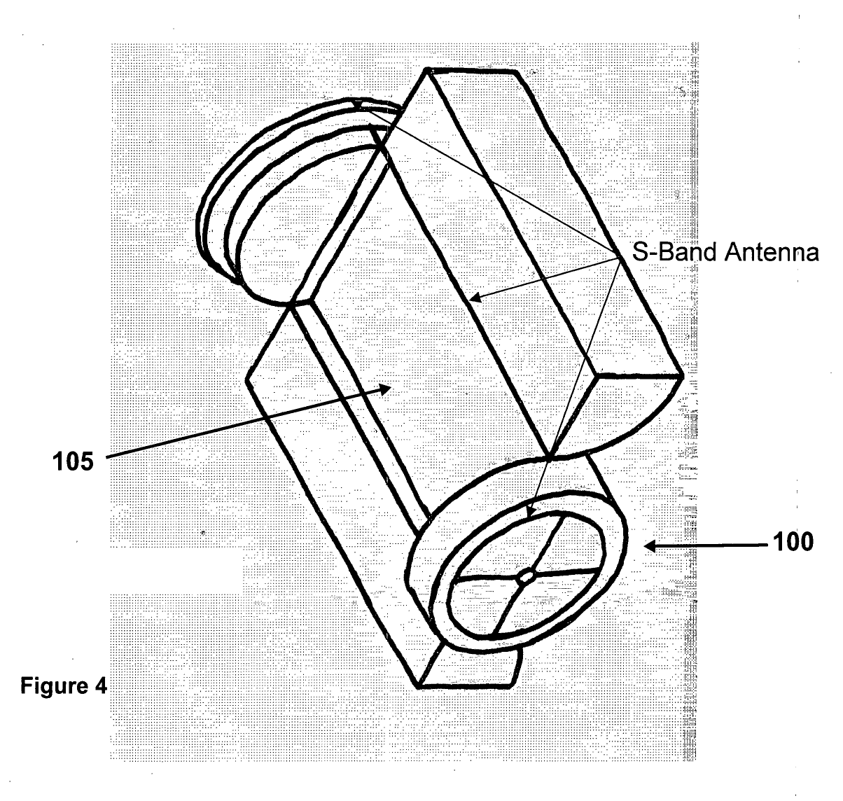

After being launched from a space flight vehicle, delivery vehicle 100 is maintained in a free flight situation in orbit as shown in FIGS. 3-4. Once deployed, it will be recognized that the attitude of delivery vehicle 100 may need to be adjusted from time to time. Attitude adjustment may be performed by propulsion system 120. Propulsion system 120 is configured to adjust the position or attitude of delivery vehicle 100 based on received control signals sent by personnel located in, for example, a Space Shuttle, space station, or on the ground. In one embodiment, control personnel may communicate with propulsion system 120 by radio signals. For example, in one embodiment guidance monitor system 110 includes a video capture device and a radio for transmitting captured images to, and for receiving command signals from, a control station. FIG. 3 illustrates an embodiment of embedding an S-band antenna in delivery vehicle 100 for radio communication. Personnel at a control station may transmit control signals to manually adjust the attitude of delivery vehicle 100 based on images obtained by the video capture device. In another embodiment, guidance monitor system 110 comprises a self-contained inertial guidance system capable of independently maintaining delivery vehicle 100 in a desired attitude (in combination with propulsion system 120).

Propulsion system 120 may comprise a cold gas system for attitude control. In one embodiment, propulsion system 120 comprises a cold gas system that uses a series of nozzles to provide between 0.1 and 15.0 pound-force of thrust for three-axis control of delivery vehicle 100. One suitable cold gas system is manufactured by VACCO Industries, Inc. of South El Monte, Calif. In general, cold gas systems suitable for use in a delivery vehicle in accordance with the invention are designed according to the principles of the American Institute of Aeronautics and Astronautics (“AIAA”) Education Series on Spacecraft Propulsion.

In addition to performing attitude adjustment operations, propulsion system 120 may be used to de-orbit delivery vehicle 100. Prior to de-orbiting, guidance monitor system 110 is be used to identify a stable reference point such as, for example, the Earth's curvature or a stellar reference point. (If guidance monitor system 110 comprises an inertial guidance system, it too may be used to provide a stable reference point.) With a stable reference, propulsion system 120 provides the necessary thrust to de-orbit delivery vehicle 100. The combined use of guidance monitor system 110 and propulsion system 120 is important to limit the area of post-flight recovery. Small errors in the attitude of delivery vehicle 100 upon de-orbit thruster firing can cause wide variations in the re-entry point along the ground track of delivery vehicle 100 as well as wide variations in cross track distances.

Delivery vehicle 100 may further comprise a second propulsion system configured to substantially change its attitude and/or inclination. For example, lifting delivery vehicle 100 into an orbit different from where it was initially deployed. In one embodiment, a SHuttle Expendable Rocket for Payload Augmentation or “SHERPA” (developed under the Air Force Research Laboratory, Space Vehicles Directorate, Kirtland AFB, New Mexico) may be used to place delivery vehicle 100 in an orbit higher than that of the vehicle used to place delivery vehicle 100 in orbit (e.g., the Space Shuttle system). Such a payload controlled expendable rocket pack can be used to change the altitude, inclination, or both of delivery vehicle 100.

Payload delivery vehicle 100 can stay in space in a free flight situation for a prolonged period of time, ranging from hours to years. FIG. 3 illustrates a closed free-flight configuration of one embodiment of the payload delivery vehicle, wherein the payload remains enclosed inside the delivery vehicle. Alternatively, the payload can be exposed to the space environment when the delivery vehicle is opened as shown in FIG. 4.

After reentry, the descent of delivery vehicle 100 is controlled by a parachute recovery system comprising a streamer 135, drogue 140, main parachute 145, and emergency parachute 150. In one embodiment, the parachute components 135-150 can be automatically deployed in three stages for a soft landing. For example, at about 100,000 feet, streamer 135 is first deployed for attitude stabilization and speed reduction. At about 50,000 feet, drogue 140 is deployed for braking. Then, at approximately 5,000 feet, main parachute 145 is deployed for soft touchdown. If there is a problem deploying main parachute 145, emergency parachute 150 can be deployed at about 4,000 feet. Drogue 140, main parachute 145, and emergency parachute 150 can be activated by a generally known mechanism such as those controlled by an accelerometer or an altimeter. Delivery vehicle 100, together with the payload contained therein, can eventually be located and retrieved based on signals emitted from beacon 130. In one embodiment, streamer 135 is made from a thermally stable, durable material including, but not limited to, NOMEX® or Kevlar®. (NOMEX and KEVLAR are registered trademarks of E. I. du Pont de Nemours and Company of Wilmington, Del.) Drogue 140 can use similar material woven into straps and sewn into a conical ribbon parachute. Main and emergency parachutes 145 and 150 may be standard military cargo parachutes or equivalents such as, for example, a G-14, 34 foot Cargo Delivery Parachute Assembly as developed by Irvin Aerospace.

1. An unmanned payload delivery vehicle, comprising:
a payload compartment configured to provide direct space exposure to one or more payloads contained therein;
a guidance monitor system configured to provide data related to a position of the payload delivery vehicle;
a communication system configured to receive control signals;
a propulsion system configured to adjust the position based on received control signals or the provided data; and
a parachute recovery system configured to deploy after activation of the propulsion system to de-orbit the unmanned payload delivery vehicle.

2. The unmanned payload delivery vehicle of claim 1, further comprising a separation system coupled to the unmanned payload delivery vehicle and configured to separate the unmanned payload delivery vehicle from a launch vehicle.

3. The unmanned payload delivery vehicle of claim 2, wherein the separation system comprises a pyrotechnic mechanism.

4. The unmanned payload delivery vehicle of claim 2, wherein the separation mechanism comprises a non-pyrotechnic lightband mechanism.

5. The unmanned payload delivery vehicle of claim 3, wherein the pyrotechnic mechanism comprises a Marmon clamp.

6. The unmanned payload delivery vehicle of 2, wherein the launch vehicle comprises an expendable launch vehicle or a Space Shuttle vehicle.

7. The unmanned payload delivery vehicle of claim 1, wherein the payload compartment is further configured to expose itself to microgravity.

8. The unmanned payload delivery vehicle of claim 1, wherein the communication system further comprises an antenna coupled to an exterior surface of the unmanned payload delivery vehicle.

9. The unmanned payload delivery vehicle of claim 1, wherein the communication system is further configured to transmit vehicle information signals.

10. The unmanned payload delivery vehicle of claim 9, wherein the vehicle information signals comprise data related to a position of the payload delivery vehicle provided by the guidance monitor system.

11. The unmanned payload delivery vehicle of claim 9, wherein the vehicle information signals comprise data related to the operation of the vehicle information signals.

12. The unmanned payload delivery vehicle of claim 1, wherein the guidance monitor system comprises a video capture device or an inertial guidance system.

13. The unmanned payload delivery vehicle of claim 1, wherein the propulsion system comprises a cold gas propulsion system.

14. The unmanned payload delivery vehicle of claim 1, wherein the propulsion system comprises a Hybrid Rocket, liquid rocket or solid rocket propulsion system.

15. The unmanned payload delivery vehicle of claim 1, further comprising a secondary propulsion system configured to substantially change an orbit of the unmanned payload delivery vehicle.

16. The unmanned payload delivery vehicle of claim 15, wherein the secondary propulsion system comprises a SHERPA propulsion system.

17. The unmanned payload delivery vehicle of claim 15, wherein the secondary propulsion system comprises any liquid, Hybrid or solid rocket.

18. The unmanned payload delivery vehicle of claim 15, further comprising a separation system configured to separate the secondary propulsion system from the rest of the unmanned payload delivery vehicle.

19. The unmanned payload delivery vehicle of claim 18, wherein the separation system comprises a pyrotechnic mechanism.

20. The unmanned payload delivery vehicle of claim 18, wherein the separation system comprises a non-pyrotechnic lightband mechanism.

21. The unmanned payload delivery vehicle of claim 20, wherein the non-pyrotechnic mechanism comprises a Marmon clamp.

22. The unmanned payload delivery vehicle of claim 1, wherein the parachute recovery system further comprises:
a streamer configured to release at a first altitude; and
a drogue configured to release at a second altitude; and
a main parachute configured to release at a third altitude.

23. The unmanned payload delivery vehicle of claim 22, further comprising an emergency parachute configured to release at a fourth altitude.

24. The unmanned payload delivery vehicle of claim 22, wherein the first altitude is determined by an altimeter device, an accelerometer device or a thermocouple device.

25. The unmanned payload delivery vehicle of claim 22, wherein the second altitude is determined by an altimeter device, an accelerometer device or a thermocouple device.

26. The unmanned payload delivery vehicle of claim 22, wherein the third altitude is determined by an altimeter device, an accelerometer device or a thermocouple device.

27. The unmanned payload delivery vehicle of claim 23, wherein the fourth altitude is determined by an altimeter device, an accelerometer device or a thermocouple device.

28. (canceled)

29. The unmanned payload delivery vehicle of claim 1, further comprising a thermal protection system configured to protect the unmanned payload delivery vehicle during re-entry to earth's atmosphere.

30. The unmanned payload delivery vehicle of claim 29, wherein the thermal protection system comprises one or more of the following materials: silicon tiles, ablative coatings, reinforced carbon-carbon and thermal blankets.

31. The unmanned payload delivery vehicle of claim 1, further comprising a beacon configured to identify a location of the unmanned payload delivery vehicle after re-entry to earth's atmosphere.

32. An unmanned payload delivery vehicle, comprising:
a payload compartment configured to provide direct space exposure to one or more payloads contained therein;
a video system configured to provide data related to a position of the payload delivery vehicle;
a radio communication system configured to receive control signals and to transmit data related to the position of the payload delivery vehicle;
a propulsion system configured to adjust the position of the unmanned payload delivery vehicle based on the received control signals or the provided data;
a parachute recovery system configured to deploy, after a de-orbit operation, a drogue at a first altitude and a main parachute at a second altitude;
a radio beacon configured to identify a location of the unmanned payload delivery vehicle after the de-orbit operation; and
a thermal protection system configured to protect the unmanned payload delivery vehicle during re-entry to earth's atmosphere.

33. The unmanned payload delivery vehicle of claim 32, further comprising a separation system coupled to the unmanned payload delivery vehicle and configured to separate the unmanned payload delivery vehicle from a launch vehicle.

34. The unmanned payload delivery vehicle of claim 33, wherein the separation system comprises a pyrotechnic mechanism or a non-pyrotechnic mechanism.

35. The unmanned payload delivery vehicle of 33, wherein the launch vehicle comprises an expendable launch vehicle.

36. The unmanned payload delivery vehicle of claim 32, wherein the payload compartment is further configured to expose itself to microgravity.

37. The unmanned payload delivery vehicle of claim 32, wherein the video system comprises a video capture device.

38. The unmanned payload delivery vehicle of claim 32, wherein the propulsion system comprises a cold gas propulsion system.

39. The unmanned payload delivery vehicle of claim 32, wherein the first altitude is determined by an altimeter device, an accelerometer device or a thermocouple device.

40. The unmanned payload delivery vehicle of claim 32, wherein the second altitude is determined by an altimeter device, an accelerometer device or a thermocouple device.

41. The unmanned payload delivery vehicle of claim 32, wherein the thermal protection system comprises one or more of the following materials: silicon tiles, ablative coatings, reinforced carbon-carbon and thermal blankets.

42. An unmanned payload delivery vehicle, comprising:
a payload compartment configured to provide direct space exposure to one or more payloads contained therein;
a guidance monitor means for providing data related to a position of the payload delivery vehicle;
a communication means for receiving control signals;
a propulsion means for adjusting the position based on the received control signals or the provided data; and
a re-entry recovery means for returning the unmanned payload vehicle to earth's surface.
